(19) United States
(12) Patent Application Publication
(10) Pub. No.: US 2009/0002427 A1
(43) Pub. Date: Jan. 1, 2009

(54) METHOD OF DETECTING MISSING NOZZLE AND INK JET PRINT HEAD USING THE SAME

(75) Inventors: Jae Sik MIN, Suwon-si (KR); Jae Young Chang, Seoul (KR); O Hyun Beak, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/050,240

(22) Filed: Mar. 18, 2008

(30) Foreign Application Priority Data
Jun. 29, 2007 (KR) 2007-65439

(51) Int. Cl. B41J 29/393

(52) U.S. Cl. 347/19

(57) ABSTRACT

A method of detecting a missing nozzle and an ink jet print head using the same, that can detect a missing nozzle immediately with a simple process when the missing nozzle is generated. The method of detecting a missing nozzle used in an ink jet print head provided with plural chambers in which an ink is filled, plural heaters corresponding to the chambers, and plural nozzles corresponding to the heaters, can include detecting a temperature of each of the nozzles, and when the detected temperature deviates from a predetermined temperature range, determining that the nozzle is a missing nozzle.

### CROSS-REFERENCE TO RELATED APPLICATIONS

This application claims the benefit of Korean Patent Application No. 2007-0065439, filed on Jun. 29, 2007 in the Korean Intellectual Property Office, the disclosure of which is incorporated herein by reference in its entirety.

### BACKGROUND OF THE INVENTION

1. Field of the Invention

The present general inventive concept relates to a method of detecting a missing nozzle and an ink jet print head using the same, and more particularly, to a method of detecting a missing nozzle and an ink jet print head using the same which can detect a missing nozzle by measuring temperatures of respective nozzles provided in an ink jet print head.

2. Description of the Related Art

An ink jet print head is a device which forms an image by ejecting ink droplets onto a desired position on a printing medium.

The ink jet print head is largely classified as an electro-thermal type and a piezoelectric type according to the ink droplet ejection mechanism. The electro-thermal type print head generates bubbles in the ink by using a heat source and ejects the ink droplets by the expansive power of the bubbles.

The electro-thermal type print head generally includes a substrate which is configured as a silicon wafer, an ink supply hole which is formed on the substrate to supply an ink, a flow channel layer which forms a flow channel and plural chambers on the substrate, a nozzle layer which is disposed on the flow channel layer and has plural nozzles corresponding to the ink chambers, and plural heaters which are provided corresponding to the ink chambers to heat the ink in the ink chambers.

In the ink jet print head, if any part of the plural nozzles is clogged or damaged when any part of the heaters or the actuators corresponding to the respective nozzles works improperly, or a circuit applying electric power to the heaters or the actuators malfunctions, white lines are formed on the printing medium, which results in deterioration of a printing quality.

A nozzle, which is damaged and cannot eject an ink, is referred to as a missing nozzle. A technique for detecting the missing nozzle and compensating for the missing nozzle to prevent the deterioration of a printing quality has been developed.

An example of a method for detecting the missing nozzle is disclosed in Korean Patent Registration No. 10-636236. The disclosed method is to detect the missing nozzle by scanning a result printed in a printing unit.

In other words, the conventional method includes printing a test pattern by ejecting the ink onto the printing medium through the nozzles, and scanning the test pattern using a scan sensor to detect the missing nozzle.

However, the conventional method for detecting the missing nozzle is troublesome and complicated and cannot detect swiftly the missing nozzle because of performing the processes of printing the test pattern and seeking out the missing nozzle through the scanning.

Further, the conventional detecting technique seeks out the missing nozzle by repeating the printing of the test pattern at a regular interval after printing for a predetermined amount of time. However, if the missing nozzle is generated right after the missing nozzle detecting process, an image of a low quality is not determined until the next missing nozzle detecting process. In other words, the conventional detecting technique cannot detect the missing nozzle immediately when the missing nozzle is generated.

Still further, the conventional missing nozzle detection wastes ink. Namely, since it is necessary to eject the ink onto the printing medium in the missing nozzle detecting process, the printing mediums or the ink are unnecessarily consumed.

Still further, because the position information of the missing nozzle is detected using the scan sensor, it is difficult to detect the position of the missing nozzle more accurately.

Japanese Patent Laid-Open Publication No. H05-309832 discloses an ink jet recording head which detects a temperature of a print head, and determines whether ink ejection of the print head is performed well, according to the detected temperature.

However, the disclosed ink jet recording head detects whether the ink is ejected well, only by measuring an average temperature of the head, but does not measure individual temperatures of the respective nozzles. Thus, the respective missing nozzles which generate white lines are not detected accurately.

### SUMMARY OF THE INVENTION

The present general inventive concept provides a method of detecting a missing nozzle and an ink jet print head using the same which can detect a missing nozzle immediately with a simple process when the missing nozzle occurs.

The present general inventive concept also provides a method of detecting a missing nozzle and an ink jet print head using the same which can detect an accurate position of the missing nozzle.

Additional aspects and/or utilities of the general inventive concept will be set forth in part in the description which follows and, in part, will be obvious from the description, or may be learned by practice of the general inventive concept.

The foregoing and/or other aspects and utilities of the present general inventive concept are achieved by providing a method of detecting a missing nozzle used in an ink jet print head provided with plural chambers in which an ink is filled, plural heaters corresponding to the chambers, and plural nozzles corresponding to the heaters, the method including detecting a temperature of each of the nozzles, and when the detected temperature deviates from a predetermined temperature range, determining that the nozzle is a missing nozzle.

The detecting may use a thin film thermocouple which is deposited adjacent to each of the nozzles.

The thin film thermocouple may be configured as a k-type thermocouple.

The predetermined temperature range may be from 40° C. to 80° C.

The foregoing and/or other aspects and utilities of the present general inventive concept may also be achieved by providing an ink jet print head including: plural nozzle modules which include chambers in which an ink is filled, nozzles corresponding to the chambers, and heaters to heat the ink in the chambers; temperature sensing parts which are provided in the respective nozzle modules to detect temperatures of the nozzles; and a control part which determines whether a missing nozzle is generated. When the detected temperature of the nozzle deviates from a predetermined temperature range, the control part determines that the nozzle is a missing nozzle.

The ink jet print head may further comprise a nozzle layer formed with the nozzles. The temperature sensing parts may be provided on the nozzle layer, adjacently to the nozzles.

The temperature sensing parts may be configured as a thin film thermocouple.

The predetermined temperature range may be from 40° C. to 80° C.

The foregoing and/or other aspects and utilities of the present general inventive concept may also be achieved by providing an ink jet print head including: a substrate which is formed with heaters and a passivation layer protecting the heaters; a flow channel layer which defines chambers corresponding to the heaters; a nozzle layer which is formed with nozzles corresponding to the chambers; temperature sensing parts which are provided on the nozzle layer, adjacently to the nozzles, to detect temperatures of the respective nozzles; and a control part which determines whether a missing nozzle is generated. When a temperature detected by the temperature sensing part deviates from a predetermined temperature range, the control part determines that the nozzle is a missing nozzle.

The temperature sensing parts may be configured as a thin film thermocouple deposited on the nozzle layer.

The control part may control an on/off state of the heaters, and the temperature sensing parts may detect the temperatures of the nozzles when the heaters are turned on.

### BRIEF DESCRIPTION OF THE DRAWINGS

These and/or other aspects and utilities of the exemplary embodiments of the present general inventive concept will become apparent and more readily appreciated from the following description of the embodiments, taken in conjunction with the accompanying drawings, of which:

FIG. 1 is a plan view schematically illustrating an ink jet print head in accordance with an embodiment of the present general inventive concept;

FIG. 2 is a sectional view taken along line I-I in FIG. 1;

FIG. 3 is a partial sectional perspective view schematically illustrating the ink jet print head in accordance with the embodiment of FIG. 1; and

FIG. 4 is a control block diagram of the ink jet print head in accordance with an embodiment of the present general inventive concept.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

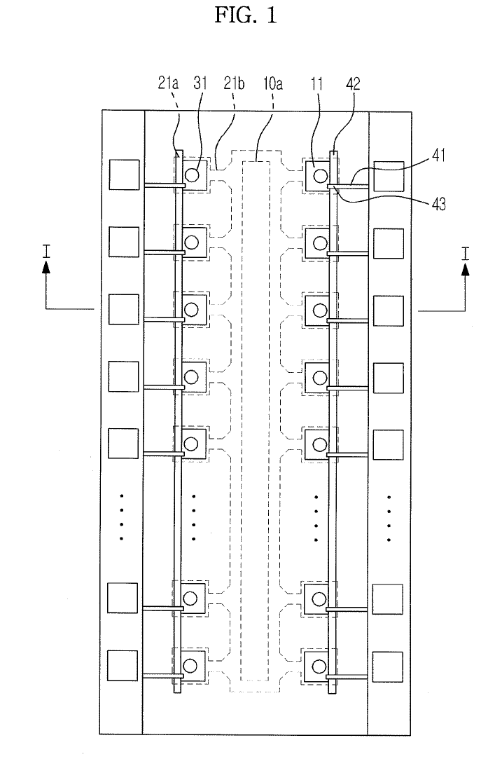

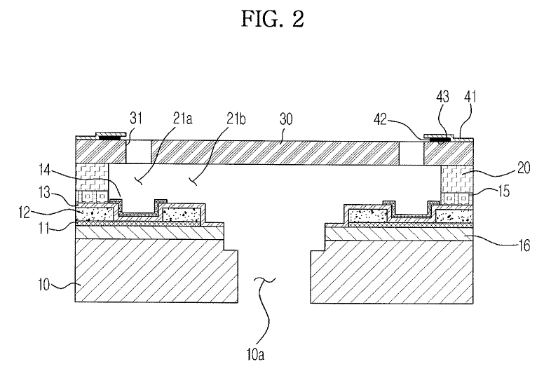

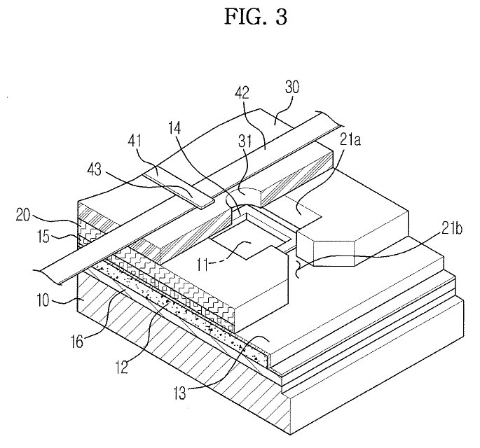

FIG. 1 is a plan view schematically illustrating an ink jet print head according to an embodiment of the present general inventive concept, FIG. 2 is a sectional view taken along line I-I in FIG. 1, and FIG. 3 is a partial sectional perspective view illustrating the ink jet print head according to the embodiment of FIG. 1.

The ink jet print head of this embodiment is preferably an electro-thermal type ink jet print head which generates bubbles in an ink using a heat source, and ejects ink droplets by an expansive power of the bubbles.

As illustrated in FIGS. 1 to 3, an embodiment of the ink jet print head may include a substrate 10, on which heaters 11 are provided as an ejection pressure generating element for ink ejection, and electrodes 12 are formed on the heaters 11. At least one of a passivation layer 13 and an anti-cavitation layer 14 may be additionally formed on the electrodes 12. Also, a flow channel layer 20 to define chambers 21a may be disposed at the substrate 10, and a nozzle layer 30 to form nozzles 31 for ink ejection may be disposed on the flow channel layer 20. A glue layer 15 may be provided between the flow channel layer 20 and the substrate 10 so that the flow channel layer 20 is stably bonded onto the substrate 10. Temperature sensing parts 43 are preferably formed at, near corresponding to or adjacent to the nozzle layer 30 to detect a temperature of the nozzles 31.

The substrate 10 can be configured as a silicon wafer, and is formed with an ink supply hole 10a through which the ink is supplied from an ink storage part (not shown). The heaters 11 provided on the substrate 10 can be configured as a typical thin film heater, and heat the ink in the chambers 21a by converting an electric signal transmitted from the electrodes 12 into a thermal energy. The heaters 11 may be made of a heat resistant material, such as tantalum nitride (TaN) or tantalum-aluminum (Ta—Al). The electrodes 12 are formed by depositing a metal material having a sufficient conductivity, such as aluminum (Al). The deposited metal layers are formed on the heaters 11 in a predetermined wiring pattern by a photolithography process and an etching process. The electrodes 12 receive a signal from a typical CMOS logic and a power transistor, and transmit the signal to the heaters 11.

A heat storage layer 16 may be provided between the heaters 11 and the substrate 10, as an insulation layer configured as a silicon oxide film. The heat storage layer 16 functions to prevent the heat generated from the heaters 11 from escaping to the substrate 10.

The passivation layer 13 protects the heaters 11 and the electrodes 12 by preventing the heaters 11 and the electrodes 12 from being oxidized or from directly contacting the ink. The passivation layer 13 may be configured as a silicon nitride (SiN) film which has good insulation properties and heat transfer efficiency. The anti-cavitation layer 14 may be provided on the passivation layer 13, above heat generating regions of the heaters 11 corresponding to the nozzles 31.

The anti-cavitation layer 14 protects the heaters 11 from a cavitation force which is generated when the bubbles in the chambers 21a contract and collapse, and prevents the heaters 11 from corroding due to the ink. The anti-cavitation layer 14 is formed by depositing tantalum (Ta) on the passivation layer 13 by a predetermined thickness.

The flow channel layer 20 defines ink passages 21 (e.g., 21a and 21b) that connect the ink supply hole 10a and the nozzles 31. The respective ink passages 21 may include chambers 21a in which the ink is filled, and restrictors 21b which connect the ink supply hole 10a and the chambers 21a.

A first metal layer 41 and a second metal layer 42, which form the temperature sensing part 43, are provided on the nozzle layer 30 to detect the temperature of the nozzle 31.

According to embodiments of the present general inventive concept, a layer (e.g., feature) is considered as being formed (or provided) “on” another layer or a substrate when formed (or provided) either directly on the referenced layer or the substrate or formed (e.g., provided) on other layers or patterns overlaying the referenced layer.

The temperature sensing part 43 may be configured as a thin film thermocouple. A temperature sensor using a temperature coefficient of resistance (TCR) may be used as a temperature sensor to detect the temperature. However, the temperature sensor using the TCR only detects an average temperature of a relatively broad area since it detects the temperature by using a resistance variation value of a metal, but cannot detect the temperature of a specific point. Accordingly, it is preferred that this embodiment is provided with the temperature sensing part 43 using the thermocouple.

The thermocouple is a temperature sensor in which two different types of metals are arranged in a closed loop, one of two junctions formed between two types of metals contacting each other in the closed loop is connected to a high-temperature side, and the other junction is connected to a low-temperature side. Such a thermocouple uses a Seeback effect such that an electromotive force is generated according to the types of metals in the closed loop and the temperature difference between the two junctions.

In this embodiment, the thermocouple is structured such that one junction between two types of metals contacting each other is directly coupled to a region, of which a temperature is to be detected, and the other opened (e.g., non-contacted) ends of two respective metals are coupled to a data acquisition board, thereby easily obtaining a temperature signal. Based on the temperature signal, the thermocouple can detect conveniently the temperature of the desired region. The thermocouple can be classified into various types according to the types of two metals comprising the thermocouple.

Preferably, a k-type thermocouple using chromel and alumel is used in the embodiment of FIG. 1.

By using the k-type thermocouple including chromel and alumel, the temperature sensing part 43 is formed such that one end of the first metal layer 41 and one end of the second metal layer 42 are bonded onto the nozzle layer 30, adjacently to the nozzle 31, so as to easily detect the temperature of the nozzle 31.

The first metal layer 41 may be formed by depositing chromel through sputtering or chemical vapor deposition, and patterning the same. Similarly, the second metal layer 42 may be formed by depositing alumel through sputtering or chemical vapor deposition, and patterning the same.

The temperature of the nozzle 31 is measured by the temperature sensing part 43. An analog signal of the measured temperature is converted into a digital signal through an A/D converter (not shown), and the digital signal is transmitted to a control part 50 (which will be described later).

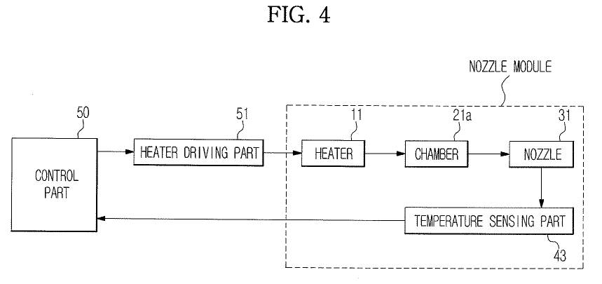

FIG. 4 is a control block diagram of the ink jet print head according to an embodiment of present general inventive concept. The ink jet print head according to this embodiment can further include a control part 50 and a heater driving part 51.

The control part 50 drives the heater 11 through the heater driving part 51 according to an input signal.

A unit nozzle module, which includes the chamber 21a defined by the flow channel layer 20, the heater 11 provided below the chamber 21a, the nozzle 31 provided above the chamber 21a, and the temperature sensing part 43 detecting the temperature of the nozzle 31, is formed in plural numbers in the ink jet print head.

In the nozzle module, the bubbles are generated in the ink in the chamber 21a by driving the heater 11 which is controlled by the control part 50, and the ink droplets are ejected through the nozzle 31 by the expansive power of the bubbles.

The temperature sensing part 43 detects continuously the temperature of the nozzle 31 when the heater 11 is driven. The temperature signal detected by the temperature sensing part 43 is transmitted to the control part 50.

When the heater 11 generates heat by the signal of the control part 50 in the normal state, because the heated ink in the chamber 21a is ejected through the nozzle 31, the nozzle 31 is kept within a predetermined temperature range. In other words, when the ink is normally ejected through the nozzle 31, the nozzle 31 is kept within a temperature range of about 60° C.±20° C., at which the bubbles are generated in the ink.

If the heater 11 generates heat while the nozzle 31 is clogged, because the ink in the chamber 21a cannot be ejected through the nozzle 31, the temperature of the nozzle 31 rises continuously over 80° C.

Also, if the heater 11 works improperly and does not generate heat, the heater 11 is kept at an ambient temperature.

When the missing nozzle is generated, i.e., the nozzle 31 is clogged or the heater 11 does not generate heat, the temperature of the nozzle 31 deviates from the predetermined temperature range (about 60° C±20° C.). Accordingly, if the control part 50 monitors continuously the temperature of the nozzle 31 and determines that the temperature of the nozzle 31 deviates from the above temperature range, the control part 50 determines that the nozzle 31 of the corresponding nozzle module is a missing nozzle.

Preferably, in order to reduce an error of the determination of the missing nozzle, if the detected temperature of the nozzle 31 is less than 40° C., the control part determines that the heater does not generate heat. And, if the detected temperature of the nozzle 31 is more than 80° C., the control part determines that the nozzle 31 is clogged and detects the missing nozzle.

After detecting the missing nozzle, the deterioration of a printing quality is prevented through various missing nozzle compensating methods. A plurality of patents related to the missing nozzle compensating methods have been filed by this applicant, and have been registered. One example of the missing nozzle compensating methods is disclosed in Korean Patent Laid-Open Publication No. 2006-0067056. Since various missing nozzle compensating methods can be adapted to this inventive concept described herein, the explanation thereof is omitted.

Since the missing nozzle is detected through the above detecting process whenever performing the printing operation, the missing nozzle can be determined promptly, when compared to a conventional missing nozzle detecting method using a scanning operation.

Also, a series of complicated processes of the printing and scanning can be omitted, and unnecessary printing operations are not carried on, thereby preventing a waste of a printing medium or an ink.

Also, since it is determined whether the missing nozzle is generated by measuring the temperature of the respective nozzles, the accurate detection of the missing nozzle can be achieved.

As apparent from the above description, the method of detecting a missing nozzle and the ink jet print head using the same according to the embodiments herein can promptly detect the missing nozzle, when compared to a conventional missing nozzle detecting method using a scanning operation, because it is determined whether the missing nozzle is generated by using the temperature of the respective nozzles whenever performing the printing operation.

Further, since it is determined whether the missing nozzle is generated by measuring the temperature of the respective nozzles, the accurate detection of the missing nozzle can be achieved.

Still further, the missing nozzle can be detected by a simple process, and unnecessary printing operations are not performed, thereby preventing a waste of a printing medium or an ink.

Although embodiments of the present general inventive concept have been shown and described, it would be appreciated by those skilled in the art that changes may be made in this embodiment without departing from the principles and spirit of the general inventive concept, the scope of which is defined in the claims and their equivalents.

What is claimed is:

1. A method of detecting a missing nozzle used in an ink jet print head provided with plural chambers in which an ink is filled, plural heaters corresponding to the chambers, and plural nozzles corresponding to the heaters, comprising:
detecting a temperature of each of the nozzles; and
when the detected temperature deviates from a predetermined temperature range, determining that the nozzle is a missing nozzle.

2. The method according to claim 1, wherein the detecting uses a thin film thermocouple which is deposited adjacent to each of the nozzles.

3. The method according to claim 2, wherein the thin film thermocouple is configured as a k-type thermocouple.

4. The method according to claim 1, wherein the predetermined temperature range is from approximately 40° C. to 80° C.

5. An ink jet print head comprising:
plural nozzle modules which include chambers in which an ink is filled, nozzles corresponding to the chambers, and heaters to heat the ink in the chambers;
temperature sensing parts which are provided in the respective nozzle modules to detect temperatures of the nozzles; and
a control part which determines whether a missing nozzle is generated,
wherein when the detected temperature of the nozzle deviates from a predetermined temperature range, the control part determines that the nozzle is a missing nozzle.

6. The ink jet print head according to claim 5, further comprising:
a nozzle layer formed with the nozzles,
wherein the temperature sensing parts are provided on the nozzle layer, adjacently to the nozzles.

7. The ink jet print head according to claim 5, wherein the temperature sensing parts are configured as a thin film thermocouple.

8. The ink jet print head according to claim 5, wherein the predetermined temperature range is from approximately 40° C. to 80° C.

9. An ink jet print head comprising:
a substrate which is formed with heaters and a passivation layer protecting the heaters;
a flow channel layer which defines chambers corresponding to the heaters;
a nozzle layer formed with nozzles corresponding to the chambers;
temperature sensing parts provided on the nozzle layer, adjacently to the nozzles, to detect temperatures of the respective nozzles; and
a control part which determines whether a missing nozzle is generated,
wherein when a temperature detected by the temperature sensing part deviates from a predetermined temperature range, the control part determines that the nozzle is a missing nozzle.

10. The ink jet print head according to claim 9, wherein the temperature sensing parts are configured as a thin film thermocouple deposited on the nozzle layer.

11. The ink jet print head according to claim 9, wherein the control part controls an on/off state of the heaters, and the temperature sensing parts detect the temperatures of the nozzles when the heaters are turned on.
